(19) United States
(12) Patent Application Publication
(10) Pub. No.: US 2023/0021253 A1
(43) Pub. Date: Jan. 19, 2023

(54) Method For Underwriting A Guaranteed Option Loan

(71) Applicant: Christopher Fritsch, Warwick, RI (US)

(72) Inventor: Christopher Fritsch, Warwick, RI (US)

(21) Appl. No.: 17/864,770

(22) Filed: Jul. 14, 2022

Related U.S. Application Data
(60) Provisional application No. 63/222,840, filed on Jul. 16, 2021.

(51) Int. Cl. G06Q 40/02

(52) U.S. Cl. CPC G06Q 40/025

(57) ABSTRACT

A method for underwriting loans is provided. In one embodiment, a lender offers a guaranteed option loan agreement without exclusion to a customer. In turn, the customer secures the option to borrow by entering into an agreement with the lender and fulfilling the guaranteed option payment(s) schedule. This underwriting method creates financial readiness for the customer; in addition to increasing access to borrowing and reducing the cost of borrowing, as compared to exclusionary underwriting methods.

### CROSS-REFERENCE TO RELATED APPLICATIONS

The application claims the benefit of U.S. Provisional Patent Application No. 63/222,840 filed Jul. 16, 2021, the entire disclosure of which is hereby incorporated by reference.

### BACKGROUND OF THE INVENTION

### Field of the Invention

The present invention relates generally to methods for underwriting loans. Particularly, in a preferred embodiment of the method, a lender offers a guaranteed option loan agreement without exclusion to a customer. In turn, the customer secures the option to borrow by entering into the agreement and fulfilling the guaranteed option payment(s) schedule. The underwriting method of this invention creates financial readiness for the customer. In addition, the method increases access to borrowing and reduces the cost of borrowing, as compared to exclusionary underwriting methods.

### Brief Review of the Related Art

The need exists for individuals and entities to establish financial readiness for expenses that will or may occur. For example, individuals must be financially ready to pay for an insurance deductible, repair of property such as a roof or car, everyday expenses during a gap in employment, etc. Many individuals are not financially prepared for such situations. They may not have appropriate savings or may not have access to affordable credit. Unlike exclusionary underwriting methods, guaranteed option loans allow any individual to proactively create financial readiness, specifically by offering guaranteed option loans without exclusion. Unlike exclusionary underwriting methods, guaranteed option loans do not require an application. Unlike exclusionary underwriting methods, guaranteed option loans do not determine the cost of borrowing based on exclusionary underwriting criteria such as employment, credit score, debt-to-income ratio, etc. Unlike insurance underwriting methods including insurance premium payment(s), guaranteed option payment(s) are refunded in full if the option to borrow is not exercised or the agreement is otherwise canceled. Unlike insurance underwriting methods, actuarial data is not used to underwrite the exchange of financial risk for profit.

The patent literature describes some exclusionary lending and insurance programs. For example, Bierer etal., U.S. Patent Application Publication 2011/0087594 describes a system and method for providing emergency reserve conditional credit to a customer of a financial institution. The emergency conditional credit may be provided to the customer in the form of a line-of-credit or a loan based on the occurrence of a predetermined condition, such as involuntary unemployment, disability or the like. To increase access, exclusionary underwriting methods may or may not be used, in conjunction with actuarial data.

McDonald, U.S. Patent Application Publication 2012/0197666 relates to methods for providing unemployment insurance products. In one example, the insurance product provides income replacement up to a certain amount in response to involuntary unemployment. Premiums are allocated to cover the cost of insurance and to fund a cash value account. More particularly, the method may include receiving information indicating the user has selected an unemployment insurance coverage option. The policy entitles the user to receive a financial benefit for a predefined period of time in response to a qualifying involuntary unemployment event and determining a premium fee to be paid on behalf of the user to maintain the policy. McDonald '0197666 also discloses that in some cases, the individual may elect to make a withdrawal from the smart cash reserve. In this regard, for example, the individual may elect to take out a loan against the smart cash reserve. Exclusionary underwriting methods may or may not be used, in conjunction with actuarial data.

### SUMMARY OF THE INVENTION

The present invention relates generally to a business method for underwriting loans, where a lender offers a guaranteed option to borrow, without exclusion. The method involves a guaranteed option loan agreement, which defines the purpose of the loan option; the payment(s), the payment(s) schedule, the loan option(s), as well as the terms and conditions. The client secures the loan guarantee by first, signing the Agreement; and second, by fulfillment of the guaranteed option payment(s) schedule. If the anticipated purpose arises or the terms and conditions of the agreement otherwise allow, the client may exercise the loan option(s). At any time, the client may cancel the agreement and receive a refund of the sum total of guaranteed option payment(s).

As discussed above, the present invention relates generally to a method for underwriting a loan based on payment(s); and specifically offering a guaranteed loan to a customer upon the customer completing the required payment(s) and subsequently exercising a loan option. The method involves establishing an account with a credit option for a customer, comprising the steps of: a) determining a payment and payment schedule and b.) determining the amount and terms of a loan available for the customer based on the payments received; For example, if a customer makes one (1) $100 payment, they are guaranteed a loan of $500. On the other hand, if a customer makes five (5) $100 payments, they are guaranteed a loan of $5000; (These examples are meant illustrative purposes only and are not meant to limit the scope of the invention); and c) allowing the customer either to complete the payment schedule and receive guaranteed access to the loan under the pre-determined amount and terms or to cancel and receive one-hundred percent (100%) of the payments previously made to the Account by the customer.

In one embodiment, the method for underwriting the guaranteed loan option comprises the steps of:

a) determining terms and conditions for a customer account, wherein the terms and conditions provide for a loan purpose, loan amount, payment amounts, payment schedule, and loan option for a customer;

b) entering into an agreement with a customer to establish a customer account based on the terms in Step a) and receiving at least one payment from a customer for the account; and

c) allowing the customer either to maintain the option to borrow and have access to the loan option under the pre-determined terms and conditions; or to cancel the agreement and receive one-hundred percent (100%) of the guaranteed option payment(s) previously made by the customer.

Preferably, the terms and conditions are determined by a lender that is underwriting the guaranteed loan option. In one example, the customer elects to maintain the account and have access to the loan option under the pre-determined terms and conditions. In another example, the customer elects to cancel the account and receive one-hundred percent (100%) of the payments previously made to the account by the customer.

### BRIEF DESCRIPTION OF THE DRAWINGS

The novel features that are characteristic of the present invention are set forth in the appended claims. However, the preferred embodiments of the invention, together with further objects and attendant advantages, are best understood by reference to the following detailed description in connection with the accompanying drawings in which:

FIG. 1 is a is a flow diagram of an underwriting method for method for offering a guaranteed option loan to a customer, without exclusion;

FIG. 2 is a flow diagram of a method for method for offering a guaranteed option loan to a customer, without exclusion; upon the customer authorizing the guaranteed option loan agreement, wherein the lender and customer steps are shown in detail in accordance with the present invention;

FIG. 3 is a flow diagram of a method for method for offering a guaranteed option loan to a customer, wherein the customer maintains the loan option by making payment(s) per the payment(s) schedule, wherein the customer maintains the right to cancel the agreement at any time, for any reason; shown in detail in accordance with the present invention;

FIG. 3A is a flow diagram of a method for method for offering a guaranteed loan to a customer upon the customer exercising a loan option showing the steps after the customer has exercised the loan option; and

FIG. 3B is a flow diagram of a method for offering a guaranteed loan to a customer upon the customer exercising a loan option showing the steps after the customer has canceled the agreement.

### DETAILED DESCRIPTION OF THE INVENTION

Different embodiments of the present invention are described below with reference to flowchart illustrations. It should be understood that each block of the flowchart illustrations can be implemented by a computer program.

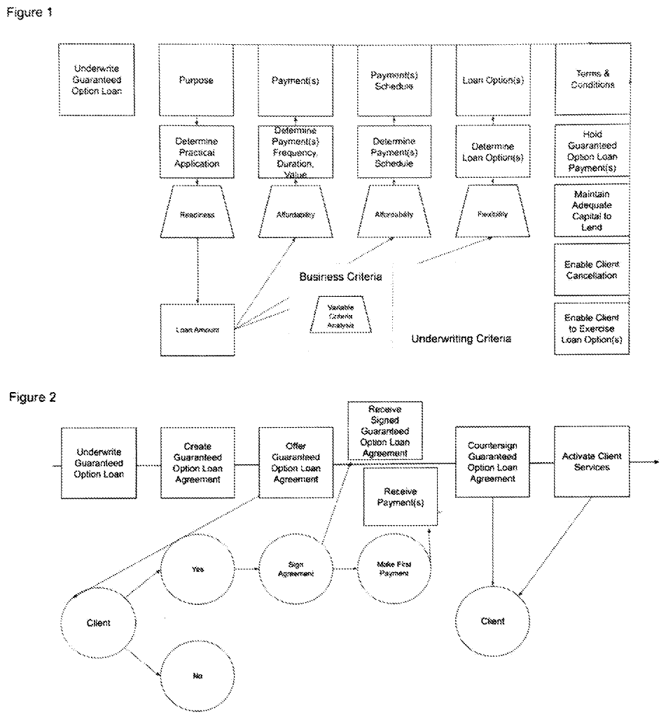

Referring to FIG. 1, in the first flowchart as set forth in the block diagrams, the method involves determining the purpose for providing the guaranteed option loan. Along with the purpose, the loan amount is determined to ensure financial readiness. In the second flowchart, the payments; particularly the frequency, duration, and value are determined. The affordability of the payments is determined. In the third flowchart, the payment schedule is determined and the affordability of making the payments according to this schedule is determined. In the fourth flowchart, the loan option(s) is determined, wherein the flexibility of the loan option(s) is determined to align with the purpose.

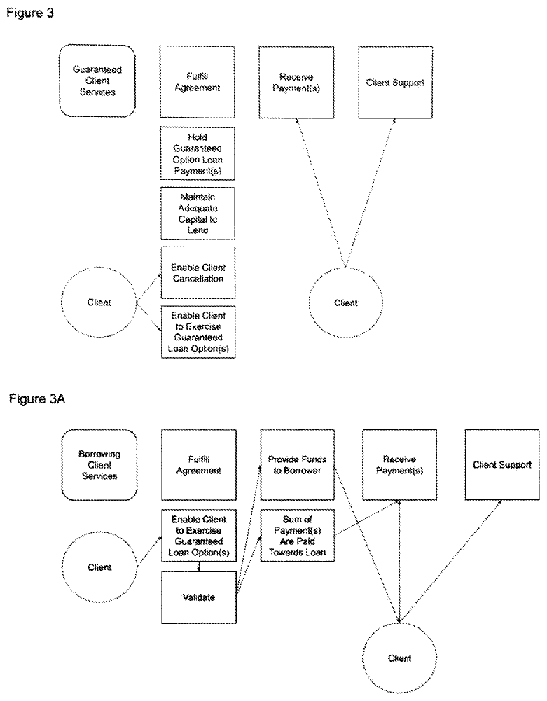

Referring to FIG. 2, in this flowchart, the steps for offering a guaranteed loan to a customer upon the customer exercising a loan option are provided. In the first step, the guaranteed option loan agreement is created. Then, the loan agreement is offered to the customer (client). If the client does not accept the loan agreement, the program terminates. If the client agrees to the loan agreement, he/she signs the agreement. The loan agreement is received by the Lender and the Lender countersigns the Option Loan Agreement. After the customer makes the first payment and it is received by the Lender, the customer services are activated and the option is secured. Continued completion of the payment(s) schedule secures the option.

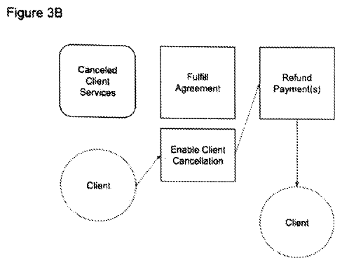

As shown in FIGS. 3, 3A, and 3B, the customer can maintain the option and have access to borrow up to the pre-determined amount and under the pre-determined terms and conditions. Alternatively, the customer can cancel the agreement and receive one-hundred (100) percent of the payments previously made.

As described above, the present invention is directed to a method for offering a guaranteed option loan to a customer. The lender first determines the appropriate loan amount(s) based on the purpose of the loan. The lender then determines the frequency, duration, and value of payment(s) that will be required by the lender to secure the loan option(s). The payment(s) are detailed for the client on a payment(s) schedule, provided along with the terms and conditions of the agreement. The loan option(s) are defined in the agreement. The lender utilizes variable criteria analysis throughout the underwriting methodology to 1.) ensure the loan amount achieves financial readiness 2.) ensure that the payment(s) for guaranteed clients are affordable, and 3.) ensure that the payment(s) for borrowing clients are affordable and flexible. The option to borrow is secured by the client as long as the payment(s) schedule is fulfilled.

The disclosed underwriting method does not involve an application, which is used in exclusionary underwriting methods. Guaranteed option lenders do not collect or utilize exclusionary underwriting criteria; such as credit score, income, debt-to-income ratio, assets, employment status, etc. In other words, in the method of the present invention, a lender offers a guaranteed option loan agreement without exclusion to a customer. The customer automatically qualifies and secures the option to borrow by entering into the agreement and fulfilling the guaranteed option payment(s) schedule. The underwriting method of this invention does not involve the costly and time-consuming steps of reviewing a customer's application and qualifications for a loan as found with traditional underwriting methods. Thus, the underwriting method of this invention creates financial readiness for the customer. This method offers many advantages over conventional underwriting methods, where many customers are excluded from gaining access to a loan. In addition, the method increases access to borrowing and reducing the cost of borrowing, as compared to exclusionary underwriting methods.

Guaranteed option lending provides increased access to loans, specifically by offering the agreement without exclusion. Prospective clients may accept the agreement if they determine there is alignment of their goals and needs with the lender's offer. The underwriting criteria are only the purpose, payment(s) amount, and fulfillment of the payment(s) schedule, and acceptance of the agreement and the terms and conditions wherein.

As discussed above, the present invention provides several benefits for underwriting loans to the customer. In particular, the lender offers a guaranteed loan to a customer upon the customer exercising a loan option. This guaranteed loan is made to the customer without exclusion. The customer is required to make cash reserve payments into their account in order to be granted the loan option. The method creates financial readiness for the customer, increases access to loans, and reduces the cost of borrowing.

Persons who lose their job or suffer an injury or have another setback, wherein they lose their income, often face significant hardships. Many people are not financially prepared for such situations. They may not have access to cash or credit. This situation can create tremendous emotional stress and strain. The present invention provides new methods for underwriting loans that can support such persons during these difficult times.

It is understood that the business methods described and illustrated herein represent only some embodiments of the invention. It is appreciated by those skilled in the art that various changes and additions can be made to the methods without departing from the spirit and scope of this invention. It is intended that all such embodiments be covered by the appended claims.

I claim:

1. A method for underwriting a guaranteed option loan comprising the steps of:
a) determining terms and conditions for a customer account, wherein the terms and conditions provide for a loan purpose, loan amount, payment amounts, payment schedule, and loan option for a customer;
b) entering into an agreement with a customer to establish a customer account based on the terms in Step a) and receiving at least one payment from a customer for the account; and
c) allowing the customer either to maintain the option to borrow and have access to the loan option under the pre-determined terms and conditions; or to cancel the agreement and receive one-hundred percent (100%) of the guaranteed option payment(s) previously made by the customer.

2. The method of claim 1, wherein the terms and conditions are determined by a lender that is underwriting the guaranteed option loan.

3. The method of claim 1, wherein the customer elects to maintain the account and have access to the loan option under the pre-determined terms and conditions.

4. The method of claim 1, wherein the customer elects to cancel the account and receive one-hundred percent (100%) of the payments previously made to the account by the customer.
